(19) United States
(12) Patent Application Publication
(10) Pub. No.: US 2017/0185874 A1
(43) Pub. Date: Jun. 29, 2017

(54) Information Processing Device, Information Process System, and Control Method of an Information Processing Device

(71) Applicant: Seiko Epson Corporation, Tokyo (JP)

(72) Inventor: Yuichi Sugiyama, Matsumoto-shi (JP)

(21) Appl. No.: 15/382,958

(22) Filed: Dec. 19, 2016

(30) Foreign Application Priority Data
Dec. 28, 2015 (JP) 2015-256842

(51) Int. Cl. G06K 15/02; H04N 1/32; G06Q 20/20; H04N 1/00

(52) U.S. Cl. CPC G06K 15/028; G06K 15/022; H04N 1/00344; H04N 1/32539; G06Q 20/209; G06Q 20/202; H04N 2201/3202

(57) ABSTRACT

An external device can use, by a simple means, information printed by a printer. A control server 15 capable of communicating with a printer 12 has a control server controller 40 that receives data from the printer 12, determines based on the received data if a previously registered specific condition is met, and if the condition is met, sends information based on the data to a store manager terminal 16.

Priority is claimed under 35 U.S.C. §119 to Japanese Application no. 2015-256842, filed on Dec. 28, 2015, which is hereby incorporated by reference in its entirety.

### BACKGROUND

1. Technical Field

The present disclosure relates to an information processing device, an information process system, and a control method of an information processing device.

2. Related Art

An information processing device (sales management servers) that connects through a network to POS terminals, receives sales information from the POS terminals, and executes processes based on the sales information is described in JP-A-2014-160400.

When building a system in which an information processing device that can communicate with other devices through a network and communicates with printers as described in claim in JP-A-2014-160400, the information the printers print may contain valuable information, and being able to use this information through an external device is desirable. To enable this, it is necessary to enable using the information printed by the printers by a simple means without the external device executing a complicated process.

### SUMMARY

The disclosure enables an external device to use, by a simple means, information printed by printers.

To achieve the foregoing objective, an aspect of the disclosure is an information processing device capable of communicating with a printer, and including: a controller configured to receive printing-related data from the printer, determining based on the received data if a previously registered specific condition is met, and if the condition is met, sending information based on the data to an external device.

When a specific condition is met, the information processing device of the disclosure sends information based on print data to an external device. The external device can therefore use, by a simple means, information printed by the printer without needing to execute a process that requests the external device for a response containing the information the user needs.

In an aspect of the disclosure, the controller, based on the data, determines the type of printout produced, and if the type of printout matches a type previously registered as a condition, sends information based on the data to the external device.

The information processing device can therefore send to the external device information based on print data related to a specific type of printout instead of all types of printouts, and information based on print data being sent unnecessarily by the information processing device to the external device can be suppressed.

In an information processing device according to another aspect of the disclosure, the printer is used in a store and can produce two types of printouts, receipts printed with information based on transactions in the store, and reports printed with information about sales during a specific time in the store; and the controller, based on the data, determines the type of printout produced, and if the type of printout matches a type previously registered as a condition, sends information based on the data to the external device.

The information processing device can therefore send to the external device information based on print data related to a specific type of printout, such as only a receipt type or a report type, instead of all types of printouts, and information based on print data being sent unnecessarily by the information processing device to the external device can be suppressed.

In information processing device according another aspect of the disclosure, the printer is used in a store and can produce three types of printouts, receipts printed with information based on transactions in the store, reports printed with information about sales during a specific time in the store, and attendance sheets printed with information related to attendance of employees employed in the store; and the controller, based on the data, determines the type of printout produced, and if the type of printout matches a type previously registered as a condition, sends information based on the data to the external device.

The information processing device can therefore send to the external device information based on print data related to a specific type of printout, such as one or more of a receipt type, a report type, and an attendance sheet type, instead of all types of printouts, and information based on print data being sent unnecessarily by the information processing device to the external device can be suppressed.

In an information processing device according to another aspect of the disclosure, the controller, based on the data received from the printer, determines if the printer that sent the data is a printer previously registered as a condition, and if the printer is the previously registered printer, sends information based on the data to the external device.

The information processing device can therefore send to the external device information based on print data related to a specific printer instead of information based on print data related to all printers, and information based on print data being sent unnecessarily by the information processing device to the external device can be suppressed.

In an information processing device according to another aspect of the disclosure, the printer is located in a store; and the controller, based on the data received from the printer, determines if the store where the printer that sent the data is a store previously registered as a condition, and if the store is the previously registered store, sends information based on the data to the external device.

The information processing device can therefore send to the external device information based on print data related to a specific store instead of information based on print data related to all stores, and information based on print data being sent unnecessarily by the information processing device to the external device can be suppressed.

An information processing device according to another aspect of the disclosure also has a specific API (Application Programming Interface) configured to process registering conditions; and the controller, when an API call statement specifying the specific API, and condition-setting information including condition information related to conditions to register, is received from a specific device, registers the condition based on the condition-setting information by the specific API specified by the API call statement.

This configuration enables a specific device, using an API on the information processing device, to define the registered conditions.

In an information processing device according to another aspect of the disclosure, the data includes print data, which is control data instructing printing, or printing-related data generated based on the print data.

The external device can therefore use, by a simple means, information printed by printers.

Another aspect of the disclosure is an information process system including a printer, and an information processing device capable of communicating with the printer, wherein: the printer sends printing-related data to the information processing device; and the information processing device receives the data from the printer, determines based on the received data if a previously registered specific condition is met, and if the condition is met, sends information based on the data to an external device.

When a specific condition is met, the information processing device of the disclosure sends information based on print data to an external device. The external device can therefore use, by a simple means, information printed by the printer without needing to execute a process that requests the external device for a response containing the information the user needs.

Another aspect of the disclosure is a control method of an information processing device capable of communicating with a printer, and including: receiving printing-related data from the printer; determining based on the received data if a previously registered specific condition is met; and if the condition is met, sending information based on the data to an external device.

When a specific condition is met, the information processing device of the disclosure sends information based on print data to an external device. The external device can therefore use, by a simple means, information printed by the printer without needing to execute a process that requests the external device for a response containing the information the user needs.

### BRIEF DESCRIPTION OF THE DRAWINGS

FIG. 1 illustrates the configuration of a network system according to the disclosure.

FIG. 2 is a block diagram of the functional configuration of devices in the network system.

FIGS. 3A, 3B and 3C are flow charts of the operation of a tablet terminal, printer, and control server.

FIG. 4 shows an example of a receipt.

FIG. 5 shows an example of a transaction information manager database.

FIGS. 6A, 6B and 6C are flow charts of the operation of a tablet terminal, printer, and control server.

FIGS. 7A and 7B show examples of an attendance sheet.

FIG. 8 shows an example of an attendance manager database.

FIGS. 9A, 9B and 9C are flow charts of the operation of a tablet terminal, printer, and control server.

FIG. 10 shows an example of a report.

FIG. 11 illustrates the structure of a report manager database.

FIGS. 12A and 12B are flow charts of the operation of a control server and store manager terminal.

FIG. 13 shows an example of a condition input screen.

FIG. 14 shows an example of an additional condition input screen.

### DESCRIPTION OF EMBODIMENTS

Preferred embodiments of the present disclosure are described below with reference to the accompanying figures.

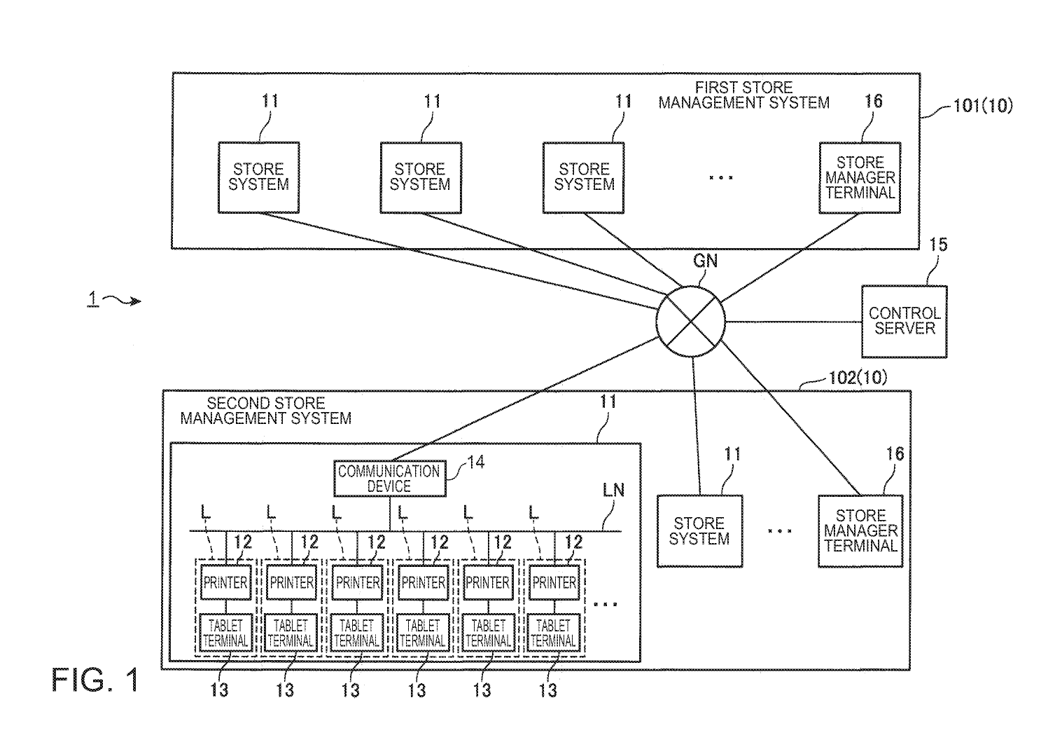

FIG. 1 shows the configuration of a network system 1 (information processing system) according to an embodiment of the disclosure.

As shown in FIG. 1, the network system 1 includes multiple store management systems 10 (two in the example in FIG. 1, first store management system 101, and second store management system 102).

The store management system 10 is a system used by a corporation that operates such businesses as supermarkets, convenience stores, department stores, or restaurants. In FIG. 1, the first store management system 101 is a system used by company K1, and the second store management system 102 is a system used by company K2. Company K1 and company K2 are completely independent companies with no business ties therebetween, and the first store management system 101 and the second store management system 102 do not exchange information with each other. Note that entities that may use the store management system 10 are not limited to corporations.

The store management system 10 includes one or more store systems 11 and a store manager terminal 16.

A store system 11 is a system that is used in retail businesses such as supermarkets, convenience stores, department stores, and restaurants. The business may be any entity in which a product is provided and a customer transaction is performed according to provision of the product. In this embodiment, the product is not limited to physical products provided to the customer, and means any object that is provided to a customer in exchange for payment, including a service provided to a customer or food or drink provided to a customer.

A checkout counter L where customer transactions are processed is located in the business where the store system 11 is deployed. A printer 12 capable of recording on roll paper (recording media) is installed at the checkout counter L. A tablet terminal 13 that connects and communicates wirelessly with the printer 12 and controls the printer 12 is also disposed at the checkout counter L.

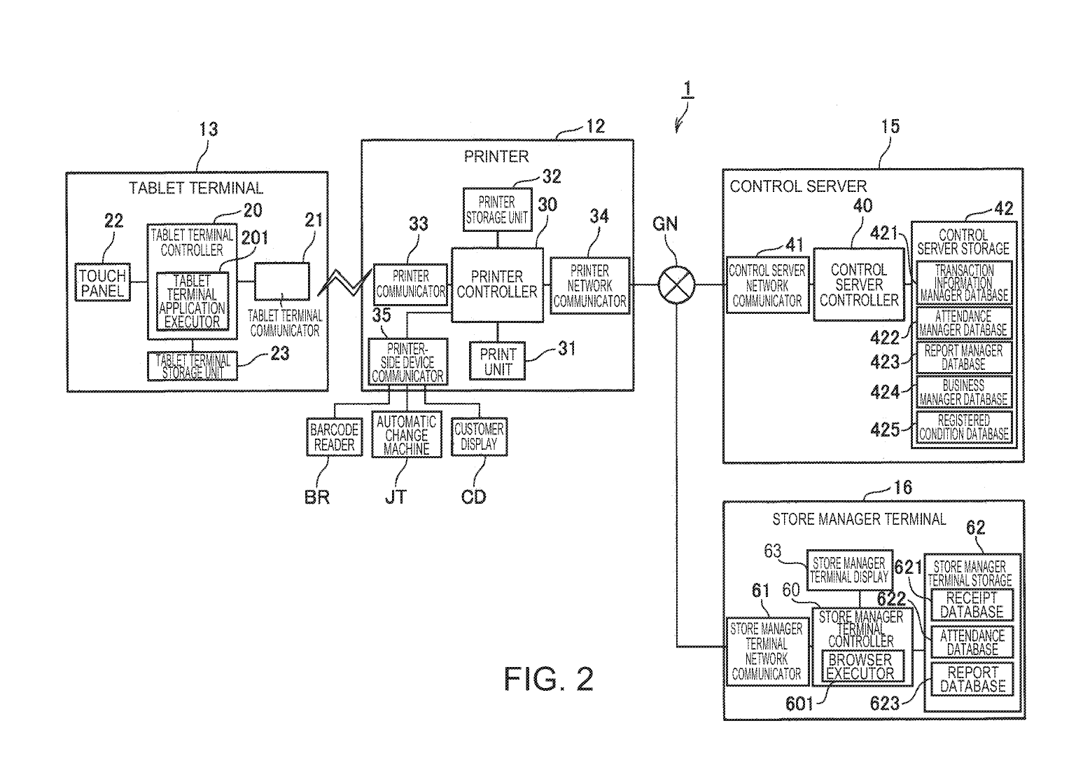

During a transaction at the checkout counter L, the cash register operator reads barcodes from the products or product packaging using a barcode reader BR (see FIG. 2) connected to the printer 12, and inputs information related to the transaction to the tablet terminal 13. The printer 12 sends data based on reading with the barcode reader BR to the tablet terminal 13. Based on the data acquired by reading with the barcode reader BR and received from the printer 12, and transaction-related input from the operator, the tablet terminal 13 causes the printer 12 to produce a receipt. The receipt produced by the printer 12 is then given by the operator to the customer.

The configuration, functions, and processes based on the functions of the printer 12 and tablet terminal 13 are described further below.

A local area network LN is deployed in the store system 11.

The printer 12 connects to the local area network LN using a communication protocol used on the LAN.

A communication device 14 is also connected to the local area network LN. The communication device 14 is an interface device that connects to the local area network LN and a global network GN including the Internet, telephone network, and other communication networks. The communication device 14 has the functions of a modem (or ONU (Optical Network Unit)), a router, a NAT (Network Address Translation) unit, and a DHCP (Dynamic Host Configuration Protocol) server. The communication device 14 transfers data that is sent and received between devices when a device connected to the local area network LN and a device connected to the global network GN communicate with each other. Note that the communication device 14 is represented by a single block in FIG. 1, but the communication device 14 may comprise plural devices with different functions.

The printer 12 can also access the global network GN through the communication device 14.

The store manager terminal 16 is a terminal administered by the managing corporation. The store manager terminal 16 is located, for example, in the head office of the corporation.

The configuration, functions, and processes based on the functions of the store manager terminal 16 are described below.

As shown in FIG. 1, a control server 15 (information processing device) is connected to the global network GN. The control server 15 is a server of which the printers 12 and store manager terminals 16 are clients. More specifically, when triggered by a request from a client, for example, the control server 15 runs a specific computing process. The control server 15 sends data based on the result of the computing process to the client as needed.

Note that the control server 15 is represented by a single block in FIG. 1, but this does not mean that the server is embodied by a single server device. For example, the control server 15 may comprise a plurality of server devices. More specifically, the control server 15 may be configured in any way enabling executing the processes described below.

FIG. 2 is a block diagram illustrating the functional configuration of the tablet terminals 13, printers 12, store manager terminals 16, and control server 15 in the network system 1.

The tablet terminal 13 is a tablet (flat panel) computer with a touch panel 22 covering a large area on the front. When a transaction is processed at the checkout counter L, the tablet terminal 13 functions as a host computer that runs transaction-related processes and controls the printer 12.

As shown in FIG. 2, the tablet terminal 13 includes a tablet terminal controller 20, a tablet terminal communicator 21, a touch panel 22, and a tablet terminal storage 23.

The tablet terminal controller 20 includes a CPU, ROM, RAM, and other peripheral circuits, and controls the tablet terminal 13. A specific application (“tablet terminal application TAP” below) is preinstalled on the tablet terminal 13. The tablet terminal controller 20 functions as a tablet terminal application executor 201 by reading and running the tablet terminal application TAP and associated programs.

The tablet terminal communicator 21 communicates with the printer 12 according to a specific communication protocol as controlled by the tablet terminal controller 20. The wireless communication standard for wireless communication between the tablet terminal 13 and printer 12 may be a wireless LAN standard compatible with an ad hoc mode, a wireless LAN standard compatible with an infrastructure mode, or a near-field communication standard such as Bluetooth®, for example.

The touch panel 22 combines an LCD panel or other type of display panel, and a touch sensor overlaid to the display panel. The display panel displays images as controlled by the tablet terminal controller 20. The touch sensor detects touch operations and outputs to the tablet terminal controller 20. The tablet terminal controller 20 then executes processes appropriate to the touch operation based on input from the touch sensor.

The tablet terminal storage 23 has nonvolatile memory, and stores data.

The printer 12 is a thermal line printer that holds roll paper and forms dots on the stored roll paper with a line thermal head to print images.

As shown in FIG. 2, the printer 12 has a printer controller 30, print unit 31, printer storage 32, printer communicator 33, printer network communicator 34, and device communicator 35.

The printer controller 30 includes a CPU, ROM, RAM, and other peripheral circuits, and controls the printer 12.

The print unit 31 includes mechanisms related to printing on roll paper, such as a conveyance mechanism for conveying roll paper stored inside the cabinet of the printer 12, a printing mechanism for forming dots and printing images on the roll paper with a thermal head, and a cutter mechanism for cutting the roll paper at a specific position. As controlled by the printer controller 30, the print unit 31 conveys the roll paper with the conveyance mechanism, prints information on the roll paper by the printing mechanism while, and then cuts the roll paper at a specific position with the cutter mechanism, producing a receipt.

The printer storage 32 has nonvolatile memory and stores data.

The printer communicator 33 communicates with the tablet terminal 13 according to a specific communication protocol as controlled by the printer controller 30.

The printer network communicator 34 communicates with devices connected to the global network GN (including the control server 15) according to a specific communication protocol as controlled by the printer controller 30.

The device communicator 35 includes an interface board with ports such as a USB port, a serial communication port other than a USB port, or other type of port. A device can connect to each port. The device communicator 35 communicates with the devices connected to the printer 12 through the ports as controlled by the printer controller 30.

Note that the device communicator 35 may be configured with a wireless communication capability for communicating wirelessly with devices.

A barcode reader BR, customer display CD, and an automatic change machine JT are examples of devices connected to the printer 12 in this example.

The barcode reader BR is used to read barcodes from products and product packaging, and outputs the read result to the device communicator 35. The device communicator 35 outputs the data input from the barcode reader BR to the printer controller 30.

The customer display CD displays transaction-related information as controlled by the printer controller 30. The information presented on the customer display CD can be checked by the customer involved in the transaction at the checkout counter L.

The automatic change machine JT has a cash receiver for receiving cash inserted by the customer and a cash dispenser for dispensing change according to the amount received, and when cash is input through the cash receiver, the change due is dispensed from the cash dispenser as controlled by the printer controller 30.

The store manager terminal 16 is a terminal administered by the managing corporation.

As shown in FIG. 2, the store manager terminal 16 includes a store manager terminal controller 60, store manager terminal network communicator 61, store manager terminal storage 62, and store manager terminal display 63.

The store manager terminal controller 60 includes a CPU, ROM, RAM, and other peripheral circuits, and controls the store manager terminal 16. A browser is installed on the store manager terminal 16. The store manager terminal controller 60 functions as a browser executor 601 by reading and running the browser and associated programs.

The store manager terminal network communicator 61 communicates with devices connected to the global network GN (including the control server 15) according to a specific communication protocol as controlled by the store manager terminal controller 60.

The store manager terminal storage 62 stores data.

The store manager terminal display 63 includes an LCD panel or other type of display panel, and displays information as controlled by the store manager terminal controller 60.

The control server 15 is a server of which the printer 12 and store manager terminal 16 are clients.

As shown in FIG. 2, the control server 15 includes a control server controller 40 (controller), control server network communicator 41, and control server storage 42.

The control server controller 40 includes a CPU, ROM, RAM, and other peripheral circuits, and controls the control server 15.

The control server network communicator 41 communicates with devices connected to the global network GN (including printers 12 and store manager terminals 16) according to a specific communication protocol as controlled by the control server controller 40.

The control server storage 42 stores data.

Operation of a tablet terminal 13, printer 12, and control server 15 when a customer transaction is processed at the checkout counter L is described next.

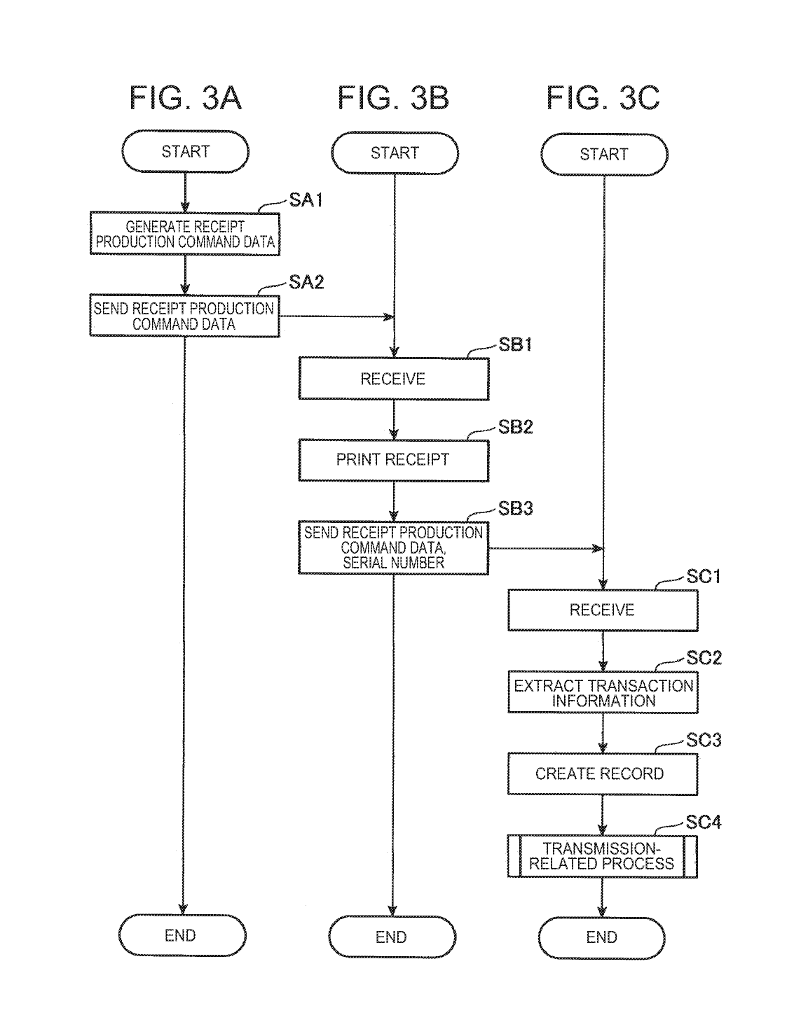

FIG. 3 is a flow chart of the operation of the tablet terminal 13, printer 12, and control server 15 when processing a transaction at the checkout counter L. FIG. 3 (A) shows the operation of the tablet terminal 13, (B) shows the operation of the printer 12, and (C) shows the operation of the control server 15.

As shown in FIG. 3 (A), the tablet terminal application executor 201 of the tablet terminal controller 20 of the tablet terminal 13 executes a transaction process according to the customer transaction, and generates receipt production command data (print data) based on the transaction process (step SA1). The receipt production command data is control data instructing producing a receipt.

More specifically, in step SA1, the tablet terminal application executor 201 generates receipt information based on input from the printer 12 (the barcode reader BR connected to the printer 12) and input from the checkout clerk on the touch panel 22 according to the customer transaction. The receipt information is information the printer 12 prints on the produced receipt. The receipt information is described more specifically below.

Next, the tablet terminal application executor 201 generates receipt production command data based on the generated receipt information. The receipt production command data is control data instructing producing a receipt with the receipt information printed according to a specific layout. The receipt production command data includes plural control commands in the command language of the printer 12.

After generating the receipt production command data in step SA1, the tablet terminal application executor 201 controls the tablet terminal communicator 21 to send the generated receipt production command data to the printer 12 (step SA2).

As shown in FIG. 3 (B), the printer controller 30 of the printer 12 controls the printer communicator 33 to receive the receipt production command data (step SB1).

Next, the printer controller 30 controls the print unit 31 to produce a receipt based on the receipt production command data received in step SB1 (step SB2). The resulting receipt is given to the customer.

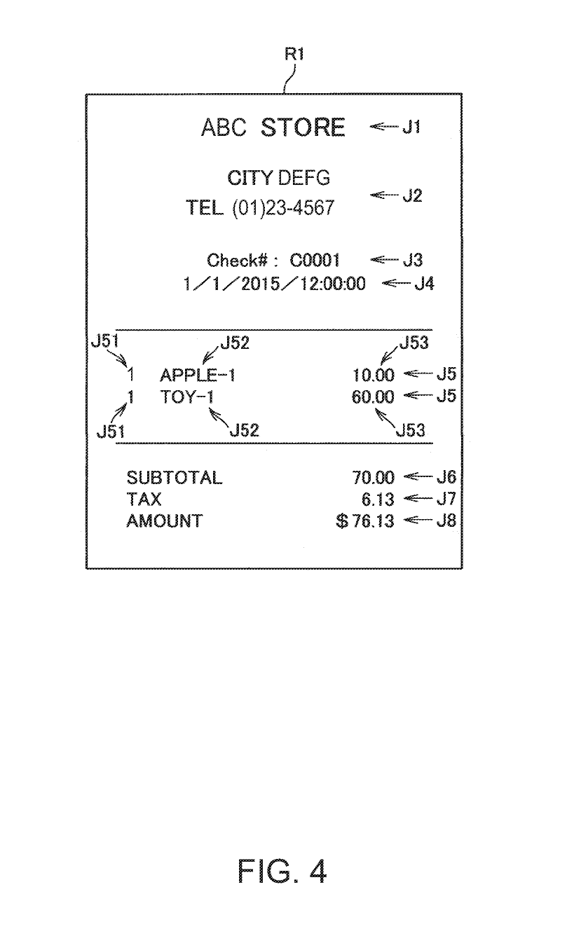

FIG. 4 shows receipt R1 as an example of a receipt produced by a printer 12 based on the receipt production command data.

Logo information J1 as a graphical representation of the name of the store is printed on the receipt R1 in FIG. 4.

Store information J2 indicating the address and telephone number of the store is also printed on the receipt R1.

Receipt identifier J3 identifying the receipt is also printed on the receipt R1.

Receipt date information J4 indicating when the receipt was produced is also printed on the receipt R1.

One or more lines of line item information J5 containing information related to the products purchased by the customer is also printed on the receipt R1. The line item information J5 includes for each product purchased by the customer: purchase quantity information J51 indicating the purchased quantity of the product, product name information J52 indicating the name of the product, and unit price information J53 indicating the price of the product.

Subtotal information J6 indicating the subtotal is also printed on the receipt R1.

Tax-related information J7 indicating the applicable taxes is also printed on the receipt R1.

Transaction total information J8 identifying the total amount of the transaction is also printed on the receipt R1.

The printer controller 30 prints the information from the logo information J1 to the transaction total information J8 based on the receipt production command data.

Next, the printer controller 30 controls the printer network communicator 34 to send the serial number J9 and the receipt production command data received in step SB1 to the control server 15 (step SB3).

The serial number J9 is identification information uniquely assigned to the printer 12 when the printer 12 is manufactured.

Note that the communication information (information related to the destination, the protocol used for communication, and the format of the transmitted data, for example) required to transmit the serial number J9 and receipt production command data in step SB3 is previously registered in the printer 12.

As shown in FIG. 3 (C), the control server controller 40 of the control server 15 controls the control server network communicator 41 to receive the serial number J9 and the receipt production command data transmitted by the printer 12 (step SC1).

Next, the control server controller 40 extracts the transaction information from the received receipt production command data (step SC2).

The transaction information is a predefined subset of the receipt information printed on the receipt. More specifically, in the sample receipt R1 shown in FIG. 4, the transaction information includes the receipt identifier J3, receipt date information J4, line item information J5 (quantity information J51, product name information J52, unit price information J53), subtotal information J6, tax information J7, and transaction total information J8.

Next, the control server controller 40 accesses the transaction information manager database 421 (database) stored on the control server storage 42, and creates a record in the transaction information manager database 421 based on the serial number J9 received in step SC1 and the transaction information extracted in step SC2 (step SC3).

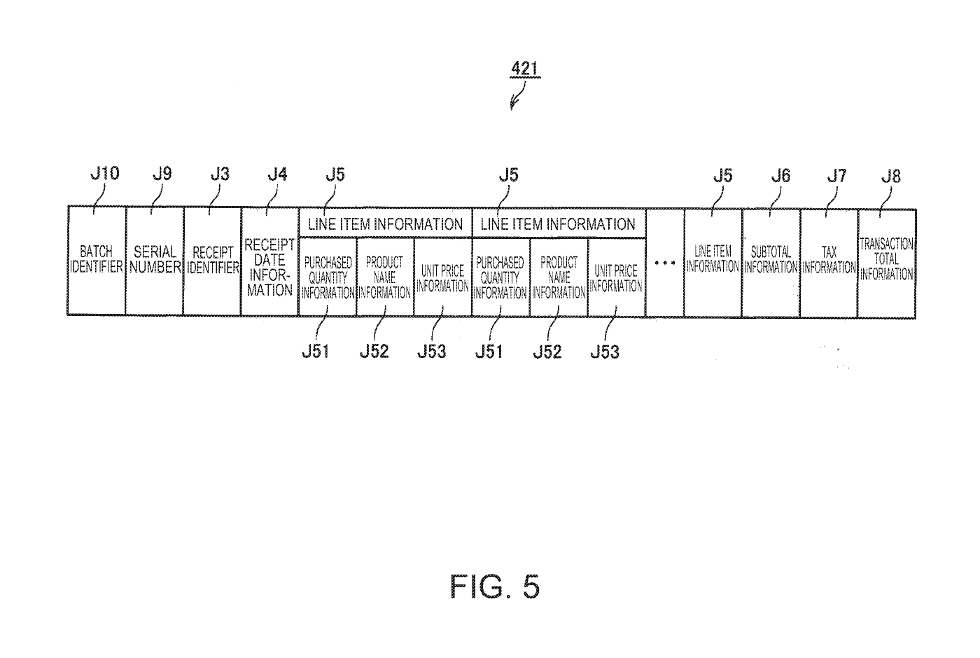

FIG. 5 shows an example of the information contained in a record of the transaction information manager database 421.

As shown in FIG. 5, each record in the transaction information manager database 421 stores a batch identifier J10, serial number J9, receipt identifier J3, receipt date information J4, one or more lines of line item information J5, subtotal information J6, tax information J7, and transaction total information J8.

The batch identifier J10 is identification information identifying a specific receipt (that is, identification information identifying the transaction related to the transaction information). The control server controller 40 generates and includes in each record batch identifier J10 of a unique value according to a specific rule.

After step SC3, the control server controller 40 executes a transmission-related process (step SC4). This transmission-related process is described further below.

Operation of a tablet terminal 13, printer 12, and control server 15 when an employee of the store clocks in to work and when the employee clocks out from work is described next.

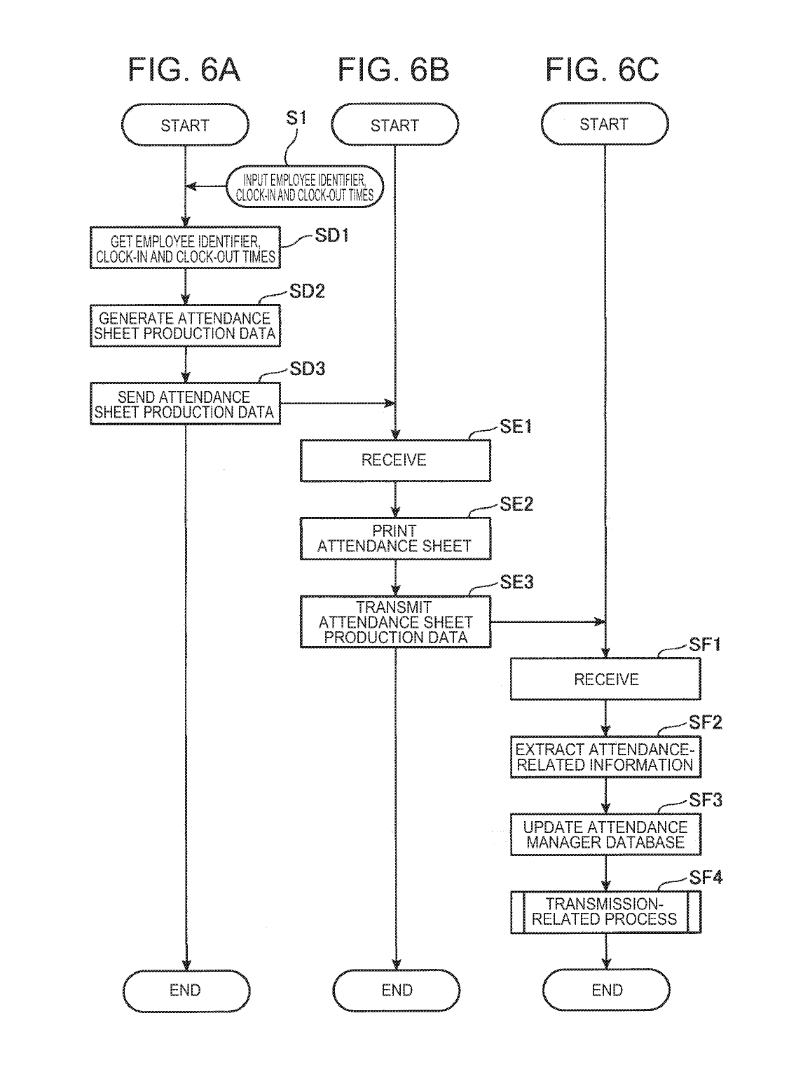

FIG. 6 is a flow chart of the operation of the tablet terminal 13, printer 12, and control server 15 when an employee of the store clocks in to work and when the employee clocks out from work. FIG. 6 (A) shows the operation of the tablet terminal 13, (B) the operation of the printer 12, and (C) the operation of the control server 15.

In a store where the store system 11 is deployed, employees of the store perform the following process when clocking in to work and when clocking out from work.

To clock in and to clock out, the employee performs a specific operation instructing the tablet terminal 13 to display a specific user interface related to attendance. In response to this instruction, the tablet terminal controller 20 of the tablet terminal 13 display the specific user interface related to attendance on the touch panel 22.

The terminal operated by the employee does not need to be a tablet terminal 13, but below the employee is a checkout clerk, and the terminal used by the employee to clock in to work and clock out is a tablet terminal 13.

The specific user interface has a field for selecting whether to input information indicating clocking in or information indicating clocking out, and an employee identifier J11 identifying the employee. The employee identifier J11 is previously assigned to the employee.

When clocking in, the employee inputs information indicating clocking in and the employee identifier J11 to the specific user interface, and when clocking out, the employee inputs the information indicating clocking out and employee identifier J11 to the specific user interface (step S1).

Below, the information indicating clocking in and information indicating clocking out are collectively referred to as attendance information.

As shown in FIG. 6 (A), the tablet terminal controller 20 of the tablet terminal 13 acquires the attendance information and employee identifier J11 input to the specific user interface (step SD1).

Next, based on the acquired attendance information and employee identifier J11, the tablet terminal controller 20 generates attendance sheet production data (print data) (step SD2). The attendance sheet production data is control data instructing producing (printing) an attendance sheet. The attendance sheet production data may include multiple control commands in the command language of the printer 12.

Next, the tablet terminal controller 20 controls the tablet terminal communicator 21 to send the generated attendance sheet production data to the printer 12 (step SD3).

As shown in FIG. 6 (B), the printer controller 30 of the printer 12 controls the printer communicator 33 to receive the attendance sheet production data (step SE1).

Next, the printer controller 30 controls the print unit 31 based on the attendance sheet production data to print an attendance sheet (step SE2).

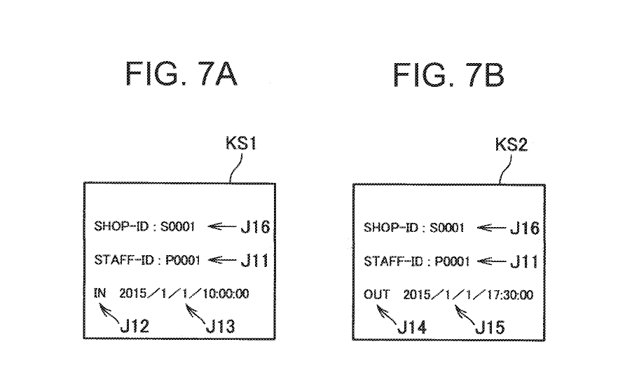

FIG. 7 (A) shows an attendance sheet KS1 as an example of an attendance sheet printed when clocking in. FIG. 7 (B) shows an attendance sheet KS2 as an example of an attendance sheet printed when clocking out.

As shown in the attendance sheets KS1, KS2 in FIG. 7 (A) and FIG. 7 (B), shop identifier J16 and employee identifier J11 are printed on the attendance sheet for clocking in and the attendance sheet for clocking out. The shop identifier J16 is information identifying the specific shop (store).

As also shown in the attendance sheet KS1 in FIG. 7 (A), the attendance sheet for clocking in also includes clock-in information J12 (“IN” in FIG. 7 (A)) showing that the employee clocked in. As also shown in the attendance sheet KS1 in FIG. 7 (A), the attendance sheet for clocking in also includes clock-in time information J13 showing when (the date (year, month, day) and time) the employee clocked in.

As also shown in the attendance sheet KS2 in FIG. 7 (B), the attendance sheet for clocking out also includes clock-out information J14 (“OUT” in FIG. 7 (B)) showing that the employee clocked out. As also shown in the attendance sheet KS2 in FIG. 7 (B), the attendance sheet for clocking out also includes clock-out time information J15 showing when (the date (year, month, day) and time) the employee clocked out.

The attendance sheets produced in step SE2 are processed according the specific rules of the shop (business).

For example, the employee may confirm the recorded clock-in time and clock-out time, and keep the attendance sheet. Or, the employee may confirm the recorded clock-in time and clock-out time, and give the attendance sheet to a specific person, such as a manager. In any event, the person that reads the attendance sheet can accurately know when the employee clocked in and clocked out, and can save the attendance sheet as a printed medium.

After producing the attendance sheet, the printer controller 30 controls the printer network communicator 34 to send the serial number J9 and attendance sheet production data to the control server 15 (step SE3).

Note that the communication information (information related to the destination, the protocol used for communication, and the format of the transmitted data, for example) required to transmit the serial number J9 and attendance sheet production data in step SE3 is previously registered in the printer 12.

As shown in FIG. 6 (C), the control server controller 40 of the control server 15 controls the control server network communicator 41 to receive the serial number J9 and attendance sheet production data (step SF1).

Next, the control server controller 40 extracts the attendance-related information from the received attendance sheet production data (step SF2).

The attendance-related information is information related to the attendance recorded on the attendance sheet. More specifically, in the attendance sheet for clocking in, the shop identifier J16, employee identifier J11, clock-in information J12, and clock-in time information J13 are the attendance-related information. In the attendance sheet for clocking out, the shop identifier J16, employee identifier J11, clock-out information J14, and clock-out time information J15 are the attendance-related information.

Next, the control server controller 40, based on the serial number J9 received in step SF1 and the attendance-related information extracted in step SF2, updates a matching record in the attendance manager database 422 stored in the control server storage 42 (step SF3). This step SF3 is described below.

The attendance manager database 422 has a record for each employee that works in each store.

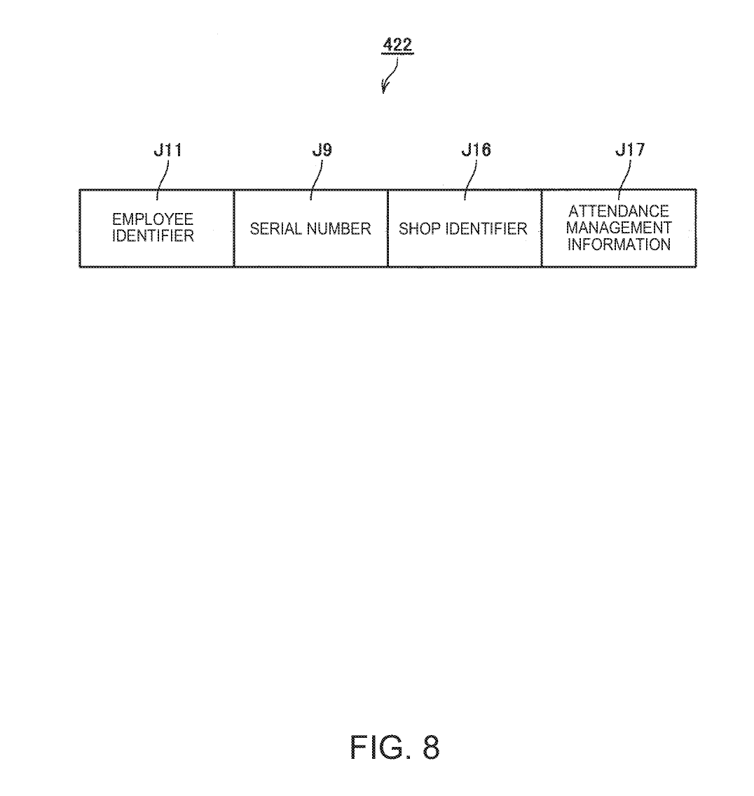

FIG. 8 shows an example of information contained in the records of the attendance manager database 422.

As shown in FIG. 8, each record of the attendance manager database 422 stores an employee identifier J11, serial number J9, and shop identifier J16.

Each record in the attendance manager database 422 also stores attendance management information J17. The attendance management information J17 cumulatively records information indicating when the employee clocked in and information indicating when the employee clocked out.

In step SF3, the control server controller 40 finds the record (corresponding record) in the attendance manager database 422 with an employee identifier J11 of the same value as the employee identifier J11 extracted as attendance-related information in step SF2. Next, the control server controller 40, based on the clock-in information J12 and clock-in time information J13, or the clock-out information J14 and clock-out time information J15, extracted in step SF2, adds the clock-in information J12 and clock-in time information J13, or the clock-out information J14 and clock-out time information J15, to the attendance management information J17.

After step SF3, the control server controller 40 executes another transmission-related process (step SF4). This transmission-related process is described further below.

As described above, the attendance manager database 422 is updated when an employee clocks-in or clocks-out from work, and when the employee clock-in and clock-out is managed in this database.

In addition to printing receipts and attendance sheets, the printer 12 can print reports. Operation of the tablet terminal 13, printer 12, and control server 15 when the printer 12 produces a report is described below together with a report.

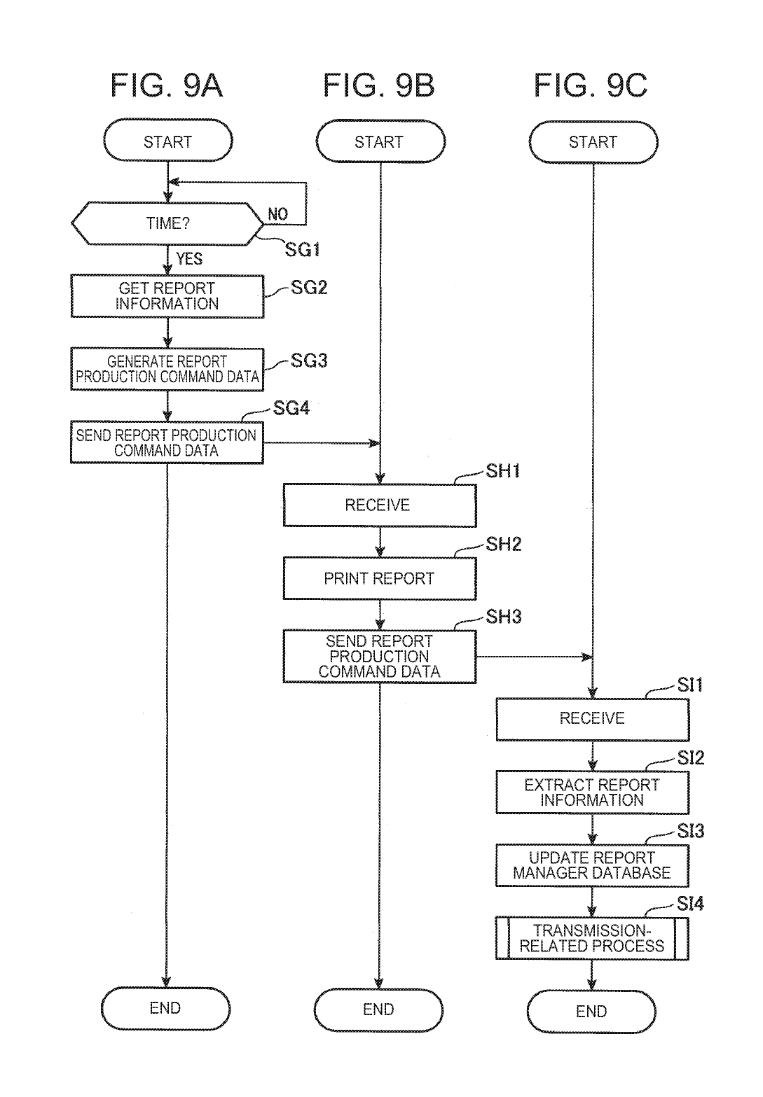

FIG. 9 is a flow chart showing the operation of the tablet terminal 13, printer 12, and control server 15 when the printer 12 produces a report. FIG. 9 (A) shows the operation of the tablet terminal 13, (B) shows the operation of the printer 12, and (C) shows the operation of the control server 15.

A report in this example is a printout of information showing sales in a store during a specific period of time. This specific period may be, a day (from store opening to closing on a particular day), a month, or a year, for example. By reading the report, a store manager, for example, can know what the store sales were during that period, and can use the information for store operations and management. A report may obviously be printed with information other than store sales during a specific period of time.

This example describes the processes of the devices when producing a report with a specific one of the tablet terminals 13 in the store having a function for producing a report from a specific corresponding printer 12. The device that controls the printer 12 to print a report is also not limited to a tablet terminal 13.

As shown in FIG. 9 (A), the tablet terminal controller 20 of the tablet terminal 13 determines if a previously set time for generating a report has come (step SG1). For example, if a report printed with sales information from the store opening to the store closing on a particular day is to be printed after the store closes, the specific time after the store closes is previously set as the time for producing the report.

Next, the tablet terminal controller 20 acquires the report information (step SG2). The report information is the information to print on the report. The tablet terminal controller 20 may, for example, acquire the report information by communicating a POS server (not shown in the figure) that manages store sales and is located in the store. The tablet terminal controller 20 may also communicate with other tablet terminals 13 through the local area network LN to acquire the sales-related information required to generate the report information, and generate the report information based on the acquired information.

Next, the tablet terminal controller 20, based on the acquired report information, generates report production command data (print data) (step SG3). The report production command data is control data instructing producing a report. The report production command data includes multiple control commands in the command language of the printer 12.

Next, the tablet terminal controller 20 controls the tablet terminal communicator 21 to send the generated report production command data to the printer 12 (step SG4).

As shown in FIG. 9 (B), the printer controller 30 of the printer 12 controls the printer communicator 33 to receive the report production command data (step SH1).

Next, the printer controller 30 controls the print unit 31 based on the report production command data to print the report (step SH2).

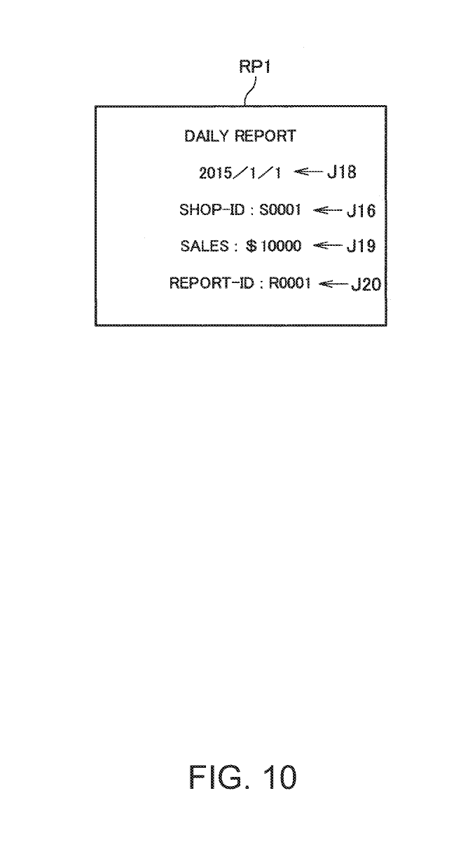

FIG. 10 shows an example of a report RP1.

As shown in the sample report RP1 in FIG. 10, sale period information J18 indicating the specific period for which sales were tabulated is printed on the report. A shop identifier J16 is also printed on the report. Sales information J19 indicating the amount of sales is also printed on the report. A report identifier J20 identifying the report is also printed on the report. The report identifier J20 is a unique value that is different on every report printed for any store.

Information other than just the sales information J19 may thus be printed on the report. For example, information related to the products that were sold in the store during the specific period, information related to the customers that made the purchased, and information about the taxes may also be printed.

After producing the report, the printer controller 30 controls the printer network communicator 34 to send the serial number J9 and report production command data to the control server 15 (step SH3).

Note that the communication information (information related to the destination, the protocol used for communication, and the format of the transmitted data, for example) required to transmit the serial number J9 and report production command data in step SH3 is previously registered in the printer 12.

As shown in FIG. 9 (C), the control server controller 40 of the control server 15 controls the control server network communicator 41 to receive the serial number J9 and report production command data (step SI1).

Next, the control server controller 40 extracts the report information from the received report production command data (step SI2). More specifically, the control server controller 40 extracts the sale period information J18, serial number J9, sales information J19, and report identifier J20 printed on the report as the report information.

Next, the control server controller 40 creates, based on the serial number J9 received in step SI1 and the report information extracted in step SI2, a record in a store database 423 stored by the control server storage 42 (step SI3).

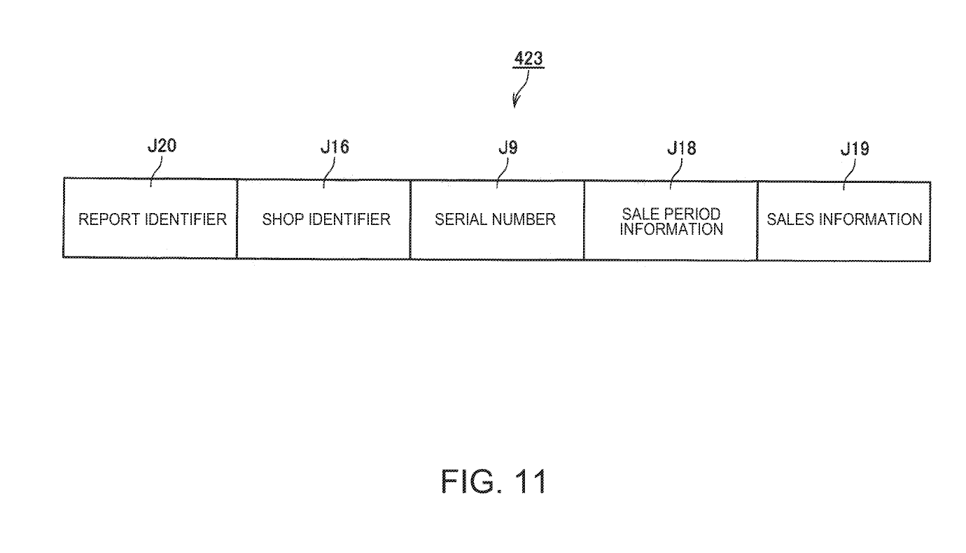

FIG. 11 shows an example of the structure of a record in the report manager database 423.

As shown in FIG. 11, each record in the report manager database 423 contains a report identifier J20, shop identifier J16, serial number J9, sale period information J18, and sales information J19.

In step S13, the control server controller 40 creates the record in the report manager database 423 based on the serial number J9 received in step SI1 and the report information extracted in step SI2.

After step S13, the control server controller 40 executes a transmission-related process (step SI4). This transmission-related process is described below.

As described above, a record is created in the report manager database 423 of the control server 15 whenever a report is printed by a specific printer 12 in the store.

The transmission-related process executed in step SC4 in FIG. 3, step SF4 in FIG. 6, and step SI4 in FIG. 9 is described below in conjunction with the operation of the store manager terminal 16 in the transmission-related process.

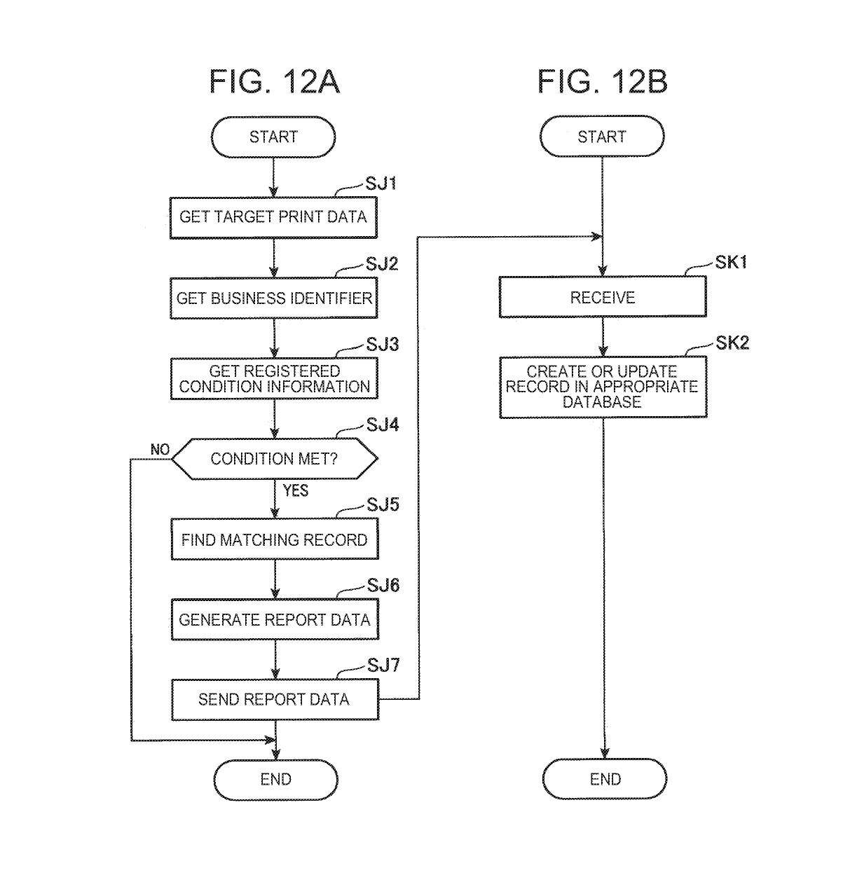

FIG. 12 is a flow chart showing the operation of the control server 15 and store manager terminal 16. FIG. 12 (A) shows the transmission-related process of the control server 15, and (B) shows the operation of the store manager terminal 16.

Below, the receipt production command data received in step SC1, the attendance sheet production data received in step SF1, and the report production command data received in step SI1, are collectively referred to below as target print data (print data).

As shown in FIG. 12 (A), in the transmission-related process, the control server controller 40 acquires the target print data (step SJ1).

Next, the control server controller 40 references a business manager database 424 stored in the control server storage 42, and acquires the business identifier J21 (information identifying a specific business) of the corresponding store (business) (step SJ2).

More specifically, the business manager database 424 has a record of each printer 12 in the store. Each record in the business manager database 424 contains the serial number J9 of the corresponding printer 12, the shop identifier J16 of the store where the printer 12 is located, and the business identifier J21 of the business that is operating the store where the printer 12 is located.

In step SJ2, the control server controller 40 finds the record with the same serial number J9 as the serial number J9 received with the target print data acquired in step SJ1. Next, the control server controller 40 acquires the business identifier J21 in the retrieved record. The business identifier J21 acquired by the control server controller 40 in step SJ2 is the business identifier J21 of the company running the store where the printer 12 that sent the target print data is located.

Next, the control server controller 40 references a registered condition database 425 stored by the control server storage 42, and acquires registered condition information J22 (described below) (step SJ3).

More specifically, the registered condition database 425 has a record for each business. Each record in the registered condition database 425 stores the business identifier J21 of the corresponding business, and registered condition information J22.

In step SJ3, the control server controller 40 finds the record with the same business identifier J21 as the business identifier J21 acquired in step SJ2. Next, the control server controller 40 acquires the registered condition information J22 from the retrieved record.

Next, the control server controller 40, based on the registered condition information J22 acquired in step SJ3 and the target print data, determines if the specific conditions previously set for the corresponding business are met (step SJ4).

More specifically, the registered condition information J22 is information containing the conditions (referred to below as a registered condition) for transmitting, to the store manager terminal 16 of the corresponding business, information (described below) based on the target print data.

The registered condition information J22 can be changed by a specific method as described below.

A registered condition is the specific type (referred to below as the registered condition type) of printout to be produced based on the target print data. There may be multiple registered condition types or none (zero).

As described above, the printer 12 in this example can produce three types of printouts, receipts, attendance sheets, and reports. As a result, a receipt type, attendance sheet type, or report type may be included in the registered condition type.

If a receipt type is included in the registered condition type, the registered condition may include the following conditions. The conditions that can be included in the registered condition when the registered condition type is a receipt type are referred to below as additional conditions.

An additional condition contained in the registered condition may be that the value of the serial number J9 of the printer 12 that sent the target print data is a specific value (that is, the condition is that the printer 12 that sent the target print data is a specific previously registered printer 12). This is referred to below as a printer-related additional condition.

Another additional condition contained in the registered condition may be that the value of the shop identifier J16 of the store where the printer 12 that sent the target print data is located is a specific value (that is, the condition is that the store where printer 12 that sent the target print data is located is a specific previously registered store). This is referred to below as a store-related additional condition.

If information indicating the registered condition type and an additional condition is included, the registered condition information J22 contains the values of one or more serial numbers J9 related to the additional conditions, or one or more shop identifiers J16 related to the additional conditions.

In step SJ4, the control server controller 40 analyzes the target print data and determines, based on the target print data, the type of printout to produce. Next, the control server controller 40, based on the registered condition information J22, acquires the registered condition type. Next, the control server controller 40 determines if the type of the printout matches one of the registered condition types.

If the type of printout is a report type, and a report type is included in the registered condition type, the control server controller 40 determines the registered condition is met.

If the type of printout is an attendance sheet type, and an attendance sheet type is included in the registered condition type, the control server controller 40 determines the registered condition is met.

If the type of printout is a receipt type, and a receipt type is included in the registered condition type, the control server controller 40 also determines if there are any additional conditions. If there is no additional condition, the control server controller 40 determines the registered condition is met. If there is an additional condition that is a printer-related additional condition, the control server controller 40 determines, based on the serial number J9, if the printer-related additional condition is met, and if the additional condition is met, determines the registered condition is met. If there is an additional condition that is a store-related additional condition, the control server controller 40 determines, based on the shop identifier J16, if the store-related additional condition is met, and if the additional condition is met, determines the registered condition is met.

If in step SJ4 the registered condition is not met (step SJ4: NO), the control server controller 40 ends the process.

If in step SJ4 the registered condition is met (step SJ4: YES), the control server controller 40 generates a record based on the target print data; or references a database (transaction information manager database 421, attendance manager database 422, or report manager database 423) of updated records, and creates or updates a record in the appropriate database (step SJ5).

Next, the control server controller 40 generates report data containing information included in the found record (information based on print data) (step SJ6).

Next, the control server controller 40 controls the control server network communicator 41 to send the resulting report data to the store manager terminal 16 (step SJ7).

Note that the communication information (information related to the destination, the protocol used for communication, and the format of the transmitted data, for example) required to transmit the report data in step SJ7 is previously registered in the control server 15.

As shown in FIG. 12 (B), the store manager terminal controller 60 of the store manager terminal 16 controls the store manager terminal network communicator 61 to receive the report data the control server 15 sent (step SK1).

Next, the store manager terminal controller 60, based on the received report data, creates or updates the corresponding record in the appropriate receipt database 621, attendance database 622, or report database 623 stored in the store manager terminal storage (step SK2).

The receipt database 621 is a database of records containing the same information as the records of the transaction information manager database 421 on the control server 15. If the report data is data generated based on records in the transaction information manager database 421, the store manager terminal controller 60 creates, based on the report data, a record in the receipt database 621.

The attendance database 622 is a database of records containing the same information as the records of the attendance manager database 422 on the control server 15. If the report data is data generated based on records in the attendance manager database 422, the store manager terminal controller 60 creates, based on the report data, a record in the attendance database 622.

The report database 623 is a database of records containing the same information as the records of the report manager database 423 on the control server 15. If the report data is data generated based on records in the report manager database 423, the store manager terminal controller 60 creates, based on the report data, a record in the report database 623.

Updating the registered condition information J22 in a record of the registered condition database 425 is described next. Updating the registered condition information J22 is the same as registering a condition.

An authorized person (referred to below as simply the user) in the company can, by the method described below, update the registered condition information J22 for that company and thereby save a registered condition.

Updating a registered condition information J22 is described below using as an example the user updating the registered condition information J22 through the store manager terminal 16. The device used to access the control server 15 to update the registered condition information J22 is not limited to the store manager terminal 16, and may be any authorized device on which a browser is installed.

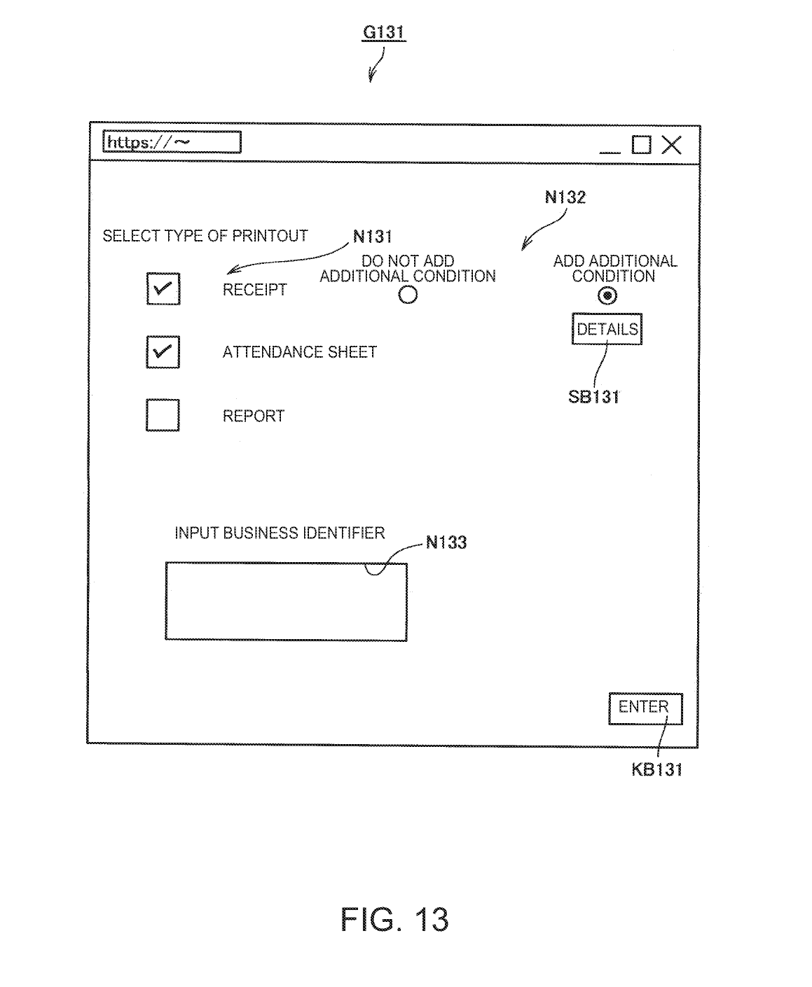

The user starts the browser on the store manager terminal 16, and accesses a specific URL on the control server 15 to display the condition input screen G131 (FIG. 13). The user is previously informed of this URL by a specific method.

The browser executor 601 of the store manager terminal controller 60 of the store manager terminal 16 accesses the specific URL on the control server 15 in response to the user command. In response to the specific URL being accessed, the control server controller 40 of the control server 15 sends an HTML file for displaying the condition input screen G131 (FIG. 13) to the store manager terminal 16.

The browser executor 601 of the store manager terminal 16 then presents the condition input screen G131 (FIG. 13) based on the received HTML file on the store manager terminal display 63.

Note that while not described in detail below, when the control server 15 is accessed from the store manager terminal 16, authentication determining if the user is a person with the specific authority is performed appropriately by a specific method.

FIG. 13 shows an example of a condition input screen G131.

As shown in FIG. 13, the condition input screen G131 has a type selection field N131. The type selection field N131 is a field for selecting the registered condition type. The type selection field N131 in this example has check boxes for selecting a receipt, attendance sheet, or report type. The user selects the desired registered condition types by checking the boxes for the desired type of printout to send to the store manager terminal 16.

The condition input screen G131 also has a business identifier input field N133. The user inputs the business identifier J21 of the user company to the business identifier input field N133.

An additional conditions selector N132 for selecting whether or not to define additional conditions as described above is also provided in the condition input screen G131 for when the receipt type is selected in the type selection field N131. The additional conditions selector N132 in this example has radio buttons for two options, shown in the example in FIG. 13 as Do Not Define Additional Conditions, and Define Additional Conditions. These radio buttons are enabled when the registered condition type Receipt is selected by checking the corresponding box in the type selection field N131.

When the registered condition type Receipt is selected, the user can click one of the radio buttons to select whether or not to define an additional condition.

If the user selects to define an additional condition, the user then operates the Details button SB131 to determine the specific content of the additional condition.

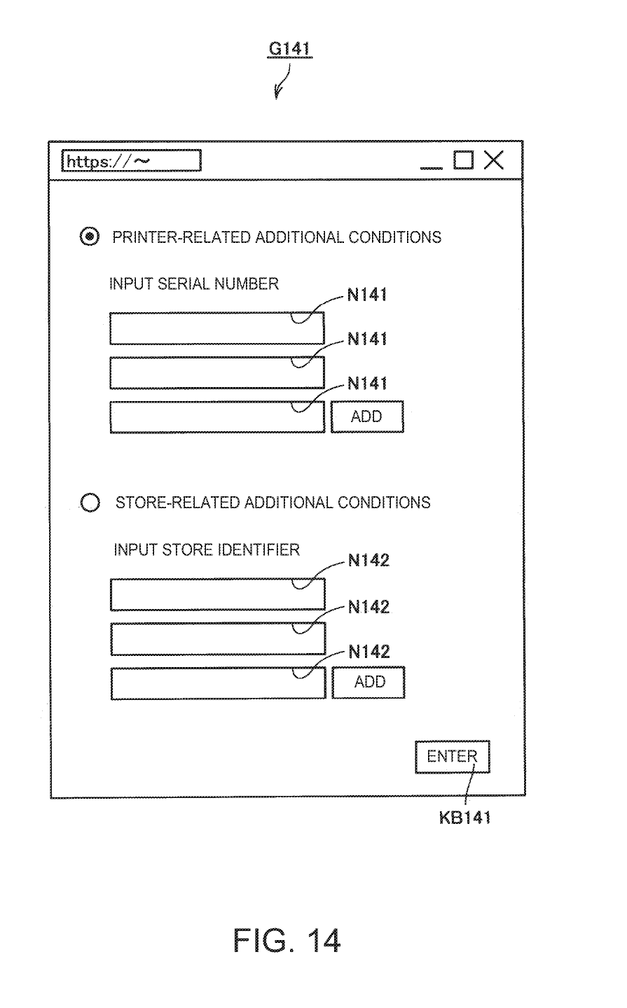

FIG. 14 shows an example of an additional condition input screen G141 that is displayed when the Details button SB131 is operated.

As shown in FIG. 14, information indicating printer-related additional conditions, information indicating store-related additional conditions, and corresponding radio buttons, are presented in the additional condition input screen G141. To define printer-related additional conditions, the user clicks the corresponding radio button. To define store-related additional conditions, the user clicks the corresponding radio button.

The additional condition input screen G141 also has multiple serial number input fields N141 for inputting printer-related additional conditions. The serial number input fields N141 are for inputting a serial number J9. When defining printer-related additional conditions is selected, the user inputs a serial number J9 to one or more serial number input fields N141.

The additional condition input screen G141 also has multiple shop identifier input fields N142 for inputting store-related additional conditions. The shop identifier input fields N142 are for inputting a shop identifier J16. When defining store-related additional conditions is selected, the user inputs a shop identifier J16 to one or more shop identifier input fields N142.

The additional condition input screen G141 also has an Enter button KB141. To confirm input to the additional condition input screen G141, the user operates the Enter button KB141.

As shown in FIG. 13, the condition input screen G131 also has an Enter button KB131. To confirm input to the condition input screen G131, the user operates the Enter button KB131.

When operation of the Enter button KB131 on the condition input screen G131 is detected, the browser executor 601 of the store manager terminal 16 acquires the information input to the condition input screen G131, and in specific cases input to the additional condition input screen G141.

More specifically, the browser executor 601 acquires information (referred to below as registered condition type information J23) indicating the type of printout (the registered condition type) selected in the type selection field N131 of the condition input screen G131.

The browser executor 601 also acquires the business identifier J21 input to the business identifier input field N133.

If the user selected to define an additional condition, the browser executor 601 acquires information indicating whether the additional conditions are printer-related additional conditions or store-related additional conditions (referred to below as additional condition type information J24).

If the additional condition type is a printer-related additional condition, the browser executor 601 acquires the one or more serial numbers J9 the user input to the serial number input fields N141 (referred to below as the additional condition serial numbers J25).

If the additional condition type is a store-related additional condition, the browser executor 601 acquires the one or more shop identifiers J16 the user input to the shop identifier input fields N142 (referred to below as the additional condition shop identifiers J26).

Next, the browser executor 601, based on the acquired information, generates an HTTP request, and sends the generated HTTP request to the control server 15. The browser executor 601 generates and sends the HTTP request by a function of a script embedded in the HTML file related to the condition input screen G131, for example.

The PUT method is used on the request line of the HTTP request. On the request line of the HTTP request are recorded the specific URL to access on the control server 15 as the pathname, and information specifying the specific corresponding Web API (referred to below as the specific Web API), according to a rule. Information to pass as parameters to the specific Web API is also recorded according to a specific rule as a query parameter in the pathname. The information to pass as parameters to the specific Web API in this example are the business identifier J21, registered condition type information J23, additional condition type information J24, additional condition serial numbers J25, and additional condition shop identifiers J26.

The registered condition type information J23, additional condition type information J24, additional condition serial numbers J25, and additional condition shop identifiers J26 in the query parameter are examples of condition information related to conditions to register.

An HTTP request related to the specific Web API is an example of an API call statement calling a specific API, and condition settings including condition information related to conditions to register.

The control server controller 40 of the control server 15 receives the HTTP request of the specific Web API that the store manager terminal 16 sent.

Next, the control server controller 40 executes the following process based on the specific Web API specified by the received HTTP request, and the query parameters (registered condition type information J23, additional condition type information J24, additional condition serial numbers J25, and additional condition shop identifiers J26).

More specifically, by a function of the specific Web API, the control server controller 40 references the registered condition database 425, and updates the content of the registered condition information J22 in the corresponding record of the database, that is, registers the conditions.

More specifically, the control server controller 40 executes the following process through functions of the specific Web API. First, the control server controller 40 finds in the records of the registered condition database 425 the record storing the same business identifier J21 as the business identifier J21 contained in the query parameter.

Next, the control server controller 40 updates the registered condition information J22 in the located record based on the registered condition type information J23, additional condition type information J24, additional condition serial numbers J25, and additional condition shop identifiers J26 in the query parameter. More particularly, the control server controller 40 overwrites the registered condition type information J23, additional condition type information J24, additional condition serial numbers J25, and additional condition shop identifiers J26 contained in the registered condition information J22 with the corresponding values contained in the query parameter.

As described above, when print data is received from the printer 12, the control server 15 sends information based on the print data (report data) to the store manager terminal 16 only when a defined condition is met, instead of always sending the information. Using a Web API on the control server 15, the user can change the registered condition for sending information. The effect of this is described below.

Specifically, the control server 15 sends report data to the store manager terminal 16 when a condition previously defined by the user is met. As a result, the store manager terminal 16 does not need to access the control server 15 to acquire information required by the user, such as by periodically executing a response request for information the user requires. As a result, the store manager terminal 16 can automatically acquire report data related to the required information. The store manager terminal 16 (external device) can therefore use, by a simple means, information printed by the printer 12.

The printer 12 can print three types of printouts, receipts, attendance sheets, and reports, and the control server 15 can, based on the printer 12 producing a printout, send report data related to information printed on the printout to the store manager terminal 16. The store manager terminal 16 can also manage, in a database, information based on the received report data.

However, the business operator does not necessarily want to receive on the store manager terminal 16 report data related to all types of printouts, or to manage on the store manager terminal 16 information based on the report data. For example, when employee attendance is managed by a specific means, the user may not want to manage information related to the attendance sheets on the store manager terminal 16.

The business operator also does not necessarily want to receive on the store manager terminal 16 report data related to receipts printed by all printers 12 in all stores managed by the company. For example, to examine transactions at a specific checkout counter L provided for a specific sales campaign in a specific store, it may be desirable to receive, on the store manager terminal 16, report data related to the receipts printed by the printer 12 at that checkout counter L, and manage information based on the report data on the store manager terminal 16.

The business operator also does not necessarily want to receive on the store manager terminal 16 report data related to receipts issued in all stores managed by the company. For example, to examine transactions in a newly opened store, it may be desirable to receive, on the store manager terminal 16, report data related to the receipts issued in that store, and manage information based on the report data on the store manager terminal 16.

Because the control server 15 sends report data to the store manager terminal 16 when a registered condition defined by the user user is met, unnecessary report data can be prevented from being sent from the control server 15 to the store manager terminal 16, and a drop in communication efficiency between the control server 15 and store manager terminal 16 can be suppressed. The control server 15 executing unnecessary processes can also be suppressed, and a drop in processing efficiency on the control server 15 can be suppressed.

As described above, an information processing device according to the disclosure has a control server controller 40 (controller) that receives print data (receipt production command data, attendance sheet production data, report production command data) from a printer 12, based on the received print data determines if a previously registered specific condition is met, and if the condition is met, sends information (report data) based on the print data to the store manager terminal 16 (external device).

When a specific condition is met, the control server 15 can therefore send information based on print data to the store manager terminal 16. The store manager terminal 16 can therefore use, by a simple means, information printed by the printer 12 without needing to execute a process that requests the control server 15 for a response containing the information the user needs.

Furthermore, because the control server 15 can therefore send information based on print data to the store manager terminal 16 when a specific condition is met, report data being sent unnecessarily from the control server 15 to the store manager terminal 16 can be suppressed, and the store manager terminal 16 can therefore efficiently use information printed by a printer based on print data.

The control server controller 40 in the disclosure determines, based on print data, the type of printout produced based on the print data, and if the type of printout matches a type previously registered as a condition, sends information based on the print data to the store manager terminal 16.

The control server 15 can therefore send to the store manager terminal 16 information based on print data related to a specific type of printout instead of all types of printouts, and information based on print data being sent unnecessarily by the control server 15 to the store manager terminal 16 can be suppressed.

A printer 12 in the disclosure is used in a store, and can produce two types of printouts, receipts printed with information based on transactions in the store, and reports printed with information about sales in the store during a specific period of time. Based on the print data, the control server controller 40 determines the type of printout produced based on the print data, and if the type of printout is the same as a type previously registered as a condition, sends information based on the print data to the store manager terminal 16.

The control server 15 can therefore send to the store manager terminal 16 information based on print data related to a specific type of printout, such as only a receipt type or a report type, instead of all types of printouts, and information based on print data being sent unnecessarily by the control server 15 to the store manager terminal 16 can be suppressed.

A printer 12 in the disclosure is used in a store, and can produce three types of printouts, receipts printed with information based on transactions in the store, reports printed with information about sales in the store during a specific period of time, and attendance sheets printed with information related to the attendance of employees working in the store. Based on the print data, the control server controller 40 determines the type of printout produced based on the print data, and if the type of printout is the same as a type previously registered as a condition, sends information based on the print data to the store manager terminal 16.

The control server 15 can therefore send to the store manager terminal 16 information based on print data related to a specific type of printout, such as one or more of a receipt type, a report type, and an attendance sheet type, instead of all types of printouts, and information based on print data being sent unnecessarily by the control server 15 to the store manager terminal 16 can be suppressed.

The control server controller 40 in the disclosure sends, based on print data received from a printer 12, information based on the print data to the store manager terminal 16 when the printer 12 that sent the print data is a printer 12 previously registered as a specific condition.

The control server 15 can therefore send to the store manager terminal 16 information based on print data related to a specific printer 12 instead of information based on print data related to all printers 12, and information based on print data being sent unnecessarily by the control server 15 to the store manager terminal 16 can be suppressed.

The control server controller 40 in the disclosure sends, based on print data received from printers 12, information based on the print data to the store manager terminal 16 when the store in which the printer 12 that sent the print data is located is a store previously registered as a specific condition.

The control server 15 can therefore send to the store manager terminal 16 information based on print data related to a specific store instead of information based on print data related to all stores, and information based on print data being sent unnecessarily by the control server 15 to the store manager terminal 16 can be suppressed.

When an API call statement calling a specific API, and condition settings including condition information related to conditions to register, are received from a store manager terminal 16 (specific device), the control server controller 40 in the disclosure registers the conditions based on the condition information by means of the Web API specified by the API call statement.

Devices such as a store manager terminal 16 can therefore use an API on the control server 15 to define the registered conditions.

The printer 12 described above is configured to send print data (receipt production command data, attendance sheet production data, or report production command data) to a control server 15 when producing a printout. The data the printer 12 sends to the control server 15 does not need to be the print data itself, however, and may be data related to or derived from the print data.

In other words, the data the printer 12 sends to the control server 15 may be data related to printing.

The printing-related data is, for example, text data containing as text information printed based on the print data. The printing-related data may also be data including information based on the print data the control server 15 needs to create a record in a specific database, or update a corresponding record in the database.

The disclosure is described above with reference to a preferred embodiment thereof, but the disclosure is not limited thereto and can be modified and adapted in many ways without departing from the scope of the accompanying claims.

For example, when the control method of the control server 15 (control method of an information processing device) described above is implemented by a computer of the control server 15, or by an external device connected to the control server 15, the disclosure can be embodied by a program the computer executes to implement the method, by a recording medium recording the program readably by a computer, or a communication medium for transmitting the program. Examples of such recording media include magnetic and optical recording media, and semiconductor memory devices. More specifically, removable or fixed storage media may be used, including floppy disks, hard disk drives (HDD), CD-ROM (Compact Disk Read Only Memory), DVD (Digital Versatile Disk), Blu-ray® Discs, magneto-optical discs, flash memory, and memory card media. The recording media may also be RAM (random access memory), ROM (read-only memory), or a hard disk drive or other nonvolatile memory used as internal storage of a device in the control server 15 or an external device connected to a device in the control server 15.

Embodiments of the disclosure are described above with reference to specific examples of information stored in databases, but the information stored in the databases is not limited thereto.

The function blocks described above with reference to the figures can be embodied as desired by the cooperation of hardware and software, and do not suggest a specific hardware configuration.

The printers 12 and tablet terminals 13 functioning as host computers above communicate wirelessly. However, communication between the printers 12 and host computers is not limited to wireless communication, and may be configured to communicate by wire using a wired LAN communication standard, USB or serial communication standard other than USB, or wired communication using a parallel communication standard. The host computer is also not limited to a tablet terminal 13 or other tablet-type device, and may be a desktop device, for example.

What is claimed is:

1. An information processing device capable of communicating with a printer, and comprising:
a controller configured to receive printing-related data from the printer, determining based on the received data if a previously registered specific condition is met, and if the condition is met, sending information based on the data to an external device.

2. The information processing device described in claim 1, wherein:
the controller, based on the data, determines the type of printout produced, and if the type of printout matches a type previously registered as a condition, sends information based on the data to the external device.

3. The information processing device described in claim 2, wherein:
the printer is used in a store and can produce two types of printouts, receipts printed with information based on transactions in the store, and reports printed with information about sales during a specific time in the store; and
the controller, based on the data, determines the type of printout produced, and if the type of printout matches a type previously registered as a condition, sends information based on the data to the external device.

4. The information processing device described in claim 2, wherein:
the printer is used in a store and can produce three types of printouts, receipts printed with information based on transactions in the store, reports printed with information about sales during a specific time in the store, and attendance sheets printed with information related to attendance of employees employed in the store; and
the controller, based on the data, determines the type of printout produced, and if the type of printout matches a type previously registered as a condition, sends information based on the data to the external device.

5. The information processing device described in claim 1, wherein:
the controller, based on the data received from the printer, determines if the printer that sent the data is a printer previously registered as a condition, and if the printer is the previously registered printer, sends information based on the data to the external device.

6. The information processing device described in claim 1, wherein:
the printer is located in a store; and
the controller, based on the data received from the printer, determines if the store where the printer that sent the data is a store previously registered as a condition, and if the store is the previously registered store, sends information based on the data to the external device.

7. The information processing device described in claim 1, further comprising:
a specific API (Application Programming Interface) configured to process registering conditions; and
the controller, when an API call statement specifying the specific API, and condition-setting information including condition information related to conditions to register, is received from a specific device, registers the condition based on the condition-setting information by the specific API specified by the API call statement.

8. The information processing device described in claim 1, wherein:
the data includes print data, which is control data instructing printing, or printing-related data generated based on the print data.

9. An information process system including a printer, and an information processing device capable of communicating with the printer, wherein:
the printer sends printing-related data to the information processing device; and
the information processing device receives the data from the printer, determines based on the received data if a previously registered specific condition is met, and if the condition is met, sends information based on the data to an external device.

10. The information process system described in claim 9, wherein:
the information processing device, based on the data, determines the type of printout produced, and if the type of printout matches a type previously registered as a condition, sends information based on the data to the external device.

11. The information process system described in claim 9, wherein:
the information processing device, based on the data received from the printer, determines if the printer that sent the data is a printer previously registered as a condition, and if the printer is the previously registered printer, sends information based on the data to the external device.

12. A control method of an information processing device capable of communicating with a printer, and comprising:
receiving printing-related data from the printer;
determining based on the received data if a previously registered specific condition is met; and
if the condition is met, sending information based on the data to an external device.

13. The control method of an information processing device described in claim 12, further comprising:
determining, based on the data, the type of printout produced, and if the type of printout matches a type previously registered as a condition, sending information based on the data to the external device.

14. The control method of an information processing device described in claim 12, further comprising:
determining, based on the data received from the printer, if the printer that sent the data is a printer previously registered as a condition, and if the printer is the previously registered printer, sending information based on the data to the external device.
